(19) United States
(12) Patent Application Publication
(10) Pub. No.: US 2016/0171503 A1
(43) Pub. Date: Jun. 16, 2016

(54) SYSTEMS AND METHODS FOR PROMOTION OF SELECTED TRANSACTIONS

(71) Applicant: SOLOVEX, INC., Lake Oswego, OR (US)

(72) Inventor: David Nelsen, Lake Oswego, OR (US)

(21) Appl. No.: 14/963,150

(22) Filed: Dec. 8, 2015

Related U.S. Application Data
(60) Provisional application No. 62/091,373, filed on Dec. 12, 2014.

(51) Int. Cl. G06Q 20/42; G06Q 20/10

(52) U.S. Cl. CPC G06Q 20/42; G06Q 20/102

(57) ABSTRACT

Systems and methods for promotion of selected transactions are provided. In one embodiment, a method comprises receiving promotion information comprising a transaction selected for promotion by the user, a reimbursement amount, and a target user; transmitting a request to the target user for reimbursement for the selected transaction; and responsive to receiving approval of the request from the target user, updating an account balance and a reserve balance based on the reimbursement amount, the account balance comprising funds in an account associated with the user that are accessible to the user and the reserve balance comprising funds in the account that are inaccessible to the user. In this way, a user may be immediately reimbursed by a second user for a purchase.

### CROSS REFERENCE TO RELATED APPLICATIONS

The present application claims priority to U.S. Provisional Patent Application No. 62/091,373, entitled “SYSTEMS AND METHODS FOR YOUTH-ORIENTED MOBILE BANKING,” filed on Dec. 12, 2014, the entire contents of which are hereby incorporated by reference for all purposes.

### BACKGROUND/SUMMARY

Financial responsibility often translates to living within one's means. However, the average credit card debt per borrower in the United States is over $5,000, indicating an alarming rate of financial irresponsibility.

The burden of teaching financial literacy and responsibility often falls on parents. As a result, financial products for teenagers and young adults typically focus on parental controls, or the ability for a parent to control how his or her dependent child may use the financial product. However, while parental controls may restrain a young adult from spending irresponsibly, they offer no solution to helping young adults develop self-restraint. As such, many young adults begin spending beyond their means soon after opening their first independent bank account.

Furthermore, most young adults remain financially dependent on their parents to some extent, even after opening a bank account free of parental controls and oversight. For example, some parents help with large purchases or provide funds for groceries. However, a parent may not always be around his or her child, and may therefore not always know how the money provided to the child is being spent.

In addition, a parent may encounter difficulties in providing his or her child with money, especially in cases where the parent and the child do not live together (e.g., when the child is in college). For example, transferring money between bank accounts may take at least one to two business days. Such delays can be frustrating, especially during an emergency where the child may need quick access to cash.

The inventor has recognized the above issues and has devised several approaches to address them. In particular, systems and methods for youth-oriented banking are provided. In one embodiment, a system comprises a first user device, a second user device, and a server communicatively coupled to the first user device and the second user device. The server is configured with instructions in non-transitory memory that when executed cause the server to: transmit, to the second user device, a promotion received from the first user device; receive a decision regarding the promotion from the second user device; update a reserve balance and a main balance based on the decision; and transmit the decision, the updated reserve balance, and the updated main balance to the first user device. In the context of the present disclosure, a promotion comprises a transaction selected by a first user, such as a child, for reimbursement by a second user, such as a parent, and therefore a first user may promote, or select and send, a transaction for reimbursement to a second user. In this way, a child may be immediately reimbursed by a parent for a purchase.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a block diagram illustrating an example computing environment according to an embodiment.

FIG. 2 shows a block diagram illustrating an example promotion engine according to an embodiment.

FIG. 3 shows a high-level flow chart illustrating an example method for promoting purchased items to a secondary user according to an embodiment.

FIG. 4 illustrates an example graphical user interface providing a user account dashboard according to an embodiment.

FIG. 5 illustrates an example graphical user interface providing an overview of all transactions according to an embodiment.

FIG. 6 illustrates an example graphical user interface for promoting a purchased item to a secondary user according to an embodiment.

FIG. 7 illustrates an example graphical user interface enabling user confirmation of a promotion to a secondary user according to an embodiment.

FIG. 8 illustrates an example graphical user interface for confirming a promotion to a secondary user according to an embodiment.

FIG. 9 illustrates an example graphical user interface providing an individual promotion overview for a secondary user according to an embodiment.

FIG. 10 illustrates an example graphical user interface for a secondary user log-in screen according to an embodiment.

FIG. 11 illustrates an example graphical user interface for confirming an approved promotion according to an embodiment.

FIG. 12 illustrates an example graphical user interface for a dashboard overview of reimbursements for a secondary user according to an embodiment.

FIG. 13 illustrates an example graphical user interface for receiving a reimbursement from a secondary user according to an embodiment.

FIG. 14 illustrates an example graphical user interface for thanking a secondary user for a reimbursement according to an embodiment.

FIG. 15 illustrates an example graphical user interface for a secondary user declining a promoted item according to an embodiment.

FIG. 16 illustrates an example graphical user interface providing confirmation of a declined promotion according to an embodiment.

FIG. 17 illustrates an example graphical user interface for a messaging system according to an embodiment.

FIG. 18 illustrates an example graphical user interface providing details regarding a declined promotion according to an embodiment.

FIG. 19 illustrates an example graphical user interface for re-promoting a purchased item to a secondary user according to an embodiment.

### DETAILED DESCRIPTION

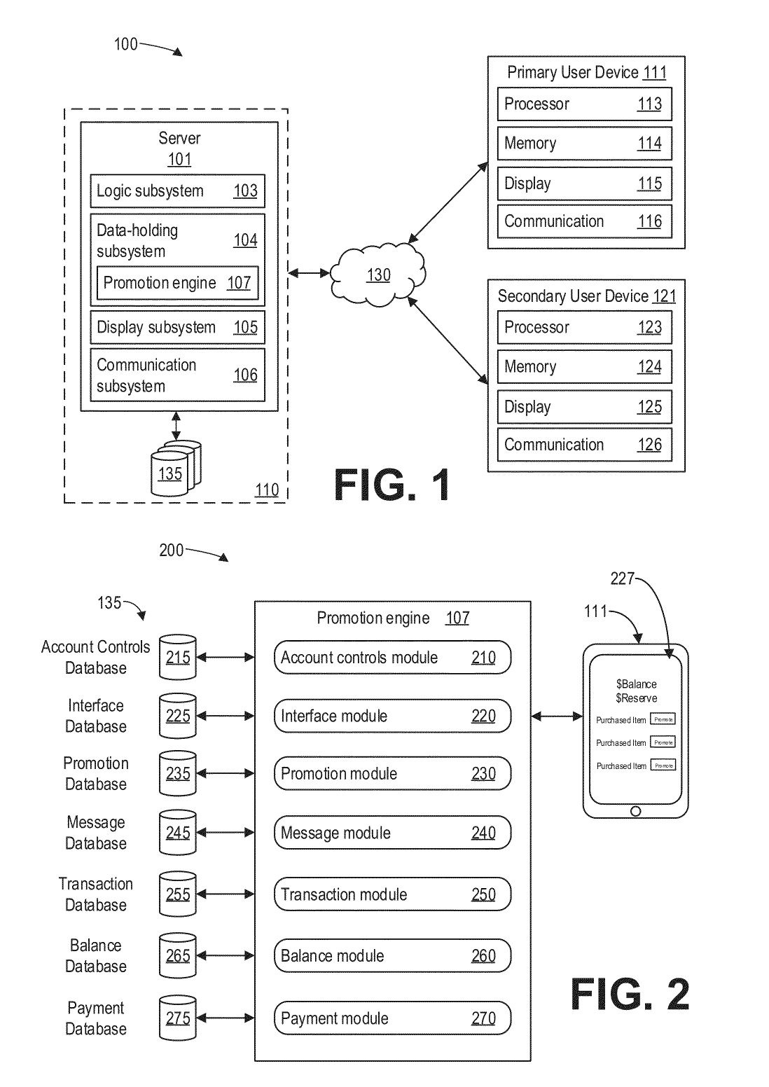

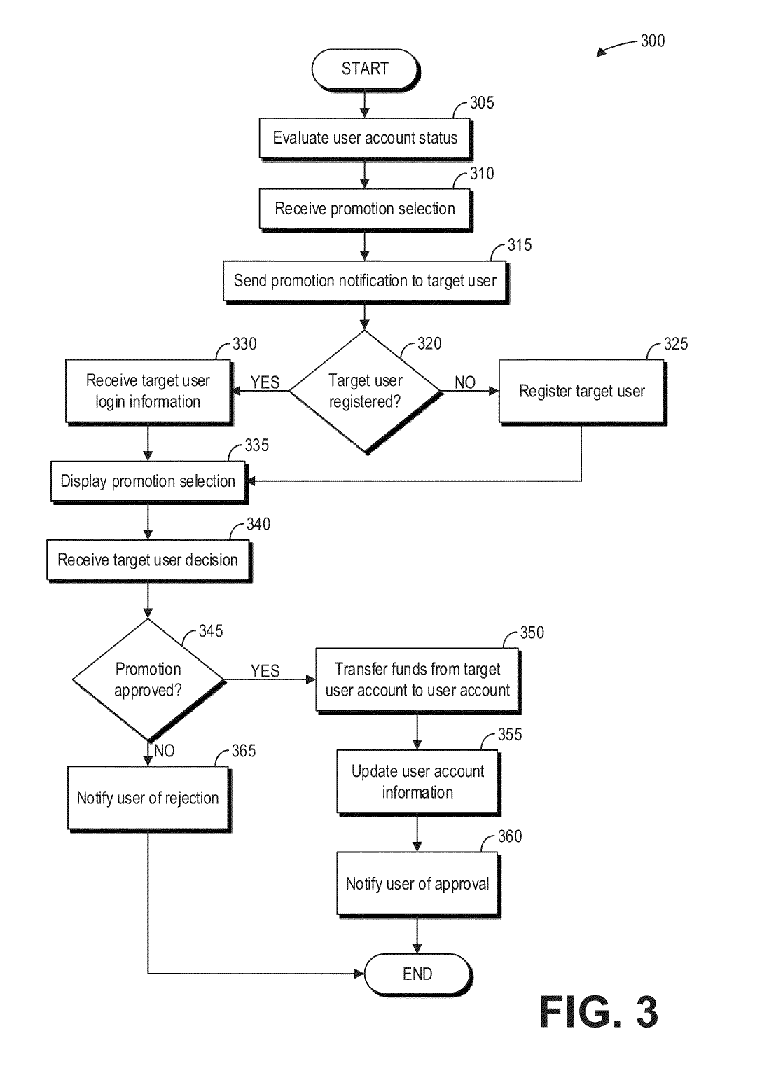

The present description relates to systems and methods for promotion of selected transactions. In particular, systems and methods for reimbursing a purchased item are provided. A child and a parent may share control of a bank account for the child via a computing environment, such as the system shown in FIG. 1. The computing environment may include a promotion engine, such as the promotion engine depicted in FIG. 2, which enables the child to promote a purchased item for reimbursement by the parent. As shown by the method depicted in FIG. 3, funds from the parent's bank account may be transferred to the child's account if the parent approves the promotion, while the child may not be reimbursed for the purchased item if the parent rejects the promotion.

As referred to herein, a primary user may comprise a dependent child while a secondary user may comprise a parent. However, those with ordinary skill in the art having the benefit of this disclosure will readily appreciate that the novel features of the present technology can be extended to a wide variety of scenarios involving a primary user and a secondary user.

FIG. 1 shows a high-level block diagram illustrating an example computing environment 100 in accordance with the current disclosure. In particular, computing environment 100 includes a server 101 communicatively coupled to a primary user device 111 and a secondary user device 121 via a network 130. The server 101 is configured to facilitate the promotion of a purchased item by a primary user of primary user device 111 and the subsequent approval or rejection of the promotion by a secondary user of secondary user device 121. However, not all of the components illustrated may be required to practice the invention. Variations in the arrangement and type of the components may be made without departing from the spirit or scope of the invention.

Server 101 may be a computing device configured to provide user interfaces that enable a primary user of server 101 to promote purchased items for reimbursement by a secondary user. In different embodiments, server 101 may take the form of a mainframe computer, server computer, desktop computer, laptop computer, tablet computer, home entertainment computer, network computing device, mobile computing device, mobile communication device, gaming device, etc.

Server 101 includes a logic subsystem 103 and a data-holding subsystem 104. Server 101 may optionally include a display subsystem 105, communication subsystem 106, and/or other components not shown in FIG. 1. For example, server 101 may optionally include user input devices such as keyboards, mice, game controllers, cameras, microphones, and/or touch screens.

Logic subsystem 103 may include one or more physical devices configured to execute one or more instructions. For example, logic subsystem 103 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 103 may include one or more processors that are configured to execute software instructions. Additionally or alternatively, the logic subsystem 103 may include one or more hardware or firmware logic machines configured to execute hardware or firmware instructions. Processors of the logic subsystem 103 may be single or multi-core, and the programs executed thereon may be configured for parallel or distributed processing. The logic subsystem 103 may optionally include individual components that are distributed throughout two or more devices, which may be remotely located and/or configured for coordinated processing. One or more aspects of the logic subsystem 103 may be virtualized and executed by remotely accessible networked computing devices configured in a cloud computing configuration.

Data-holding subsystem 104 may include one or more physical, non-transitory devices configured to hold data and/or instructions executable by the logic subsystem 103 to implement the herein described methods and processes. When such methods and processes are implemented, the state of data-holding subsystem 104 may be transformed (for example, to hold different data).

Data-holding subsystem 104 may include removable media and/or built-in devices. Data-holding subsystem 104 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 104 may include devices with one or more of the following characteristics: volatile, nonvolatile, dynamic, static, read/write, read-only, random access, sequential access, location addressable, file addressable, and content addressable. In some embodiments, logic subsystem 103 and data-holding subsystem 104 may be integrated into one or more common devices, such as an application-specific integrated circuit or a system on a chip.

Data-holding subsystem 104 may include a promotion engine 107 that when executed by logic subsystem 103 provides the functionality of the invention as described herein. In particular, promotion engine 107 enables server 101 to facilitate the promotion of a purchased item by a primary user and the approval of the promotion by a secondary user. In one example, promotion engine 107 may comprise a plurality of modules, each module configured to perform a different task or set of tasks. An example architecture for a promotion engine 107 is described further herein and with regard to FIG. 2.

When included, display subsystem 106 may be used to present a visual representation of data held by data-holding subsystem 104. As the herein described methods and processes change the data held by the data-holding subsystem 104, and thus transform the state of the data-holding subsystem 104, the state of display subsystem 106 may likewise be transformed to visually represent changes in the underlying data. Display subsystem 106 may include one or more display devices utilizing virtually any type of technology. Such display devices may be combined with logic subsystem 103 and/or data-holding subsystem 104 in a shared enclosure, or such display devices may be peripheral display devices.

When included, communication subsystem 107 may be configured to communicatively couple server 101 with one or more other computing devices. Communication subsystem 107 may include wired and/or wireless communication devices compatible with one or more different communication protocols. As non-limiting examples, communication subsystem 107 may be configured for communication via a wireless telephone network, a wireless local area network, a wired local area network, a wireless wide area network, a wired wide area network, etc. In some embodiments, communication subsystem 107 may allow server 101 to send and/or receive messages to and/or from other devices via a network such as the public Internet. For example, communication subsystem 107 may communicatively couple server 101 with primary user device 111 and secondary user device 121 via network 130.

Network 130 may comprise any communication network. In some examples, network 130 may be the public Internet. In other examples, network 130 may be regarded as a private network connection and may include, for example, a virtual private network or an encryption or other security mechanism employed over the public Internet.

The server 101 may be included in a central server apparatus 110 that further includes a data storage system storing a plurality of databases 135 that are maintained by the server 101. In some examples, the data storage system storing the plurality of databases 135 may comprise the data-holding subsystem 104 of the server 101, though it should be appreciated that in other examples the plurality of databases 135 may be stored in a separate data storage system.

As mentioned above, the computing environment 100 may include a plurality of client devices, including at least a primary user device 111 and a secondary user device 121. It should be appreciated that although a single primary user device 111 and a single secondary user device 121 are depicted in FIG. 1, in some examples the computing environment 100 may include a plurality of primary user devices 111 and a plurality of secondary user devices 121.

Primary user device 111 may comprise a computing device configured to display one or more user interfaces output by server 101. Additionally, primary user device 111 may be further configured to transmit user input to server 101. As such, primary user device 111 may include a processor 113, memory 114, display 115, and a communication subsystem 116. Primary user device 111 is shown in simplified form. However, primary user device 111 may take the form of one or more personal computers, server computers, tablet computers, home entertainment computers, network computing devices, gaming devices, mobile computing devices, mobile communication devices (for example, smart phone, smart watch, etc.), and/or other computing devices.

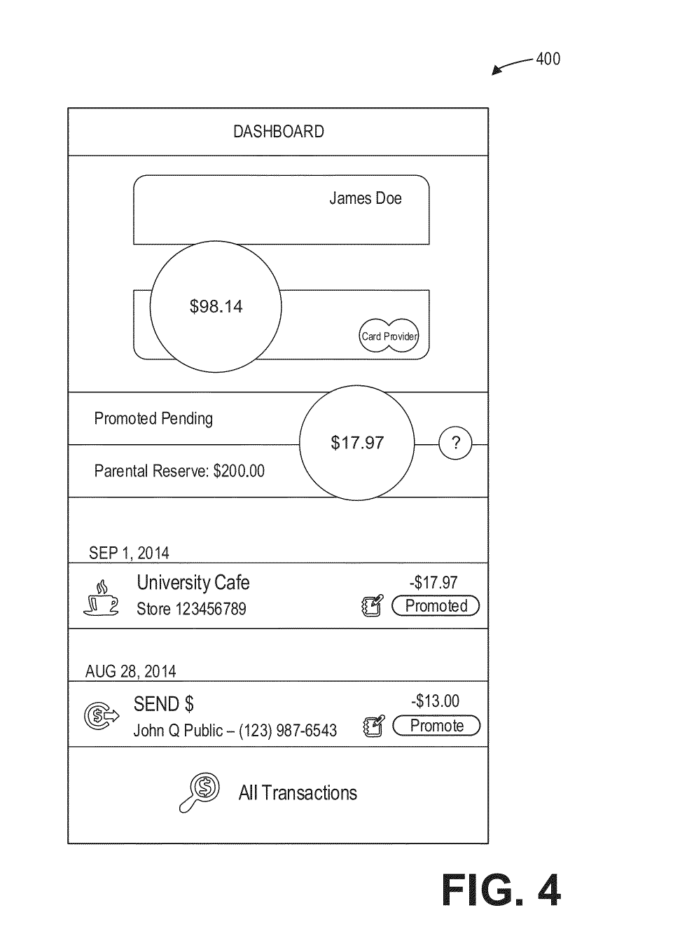

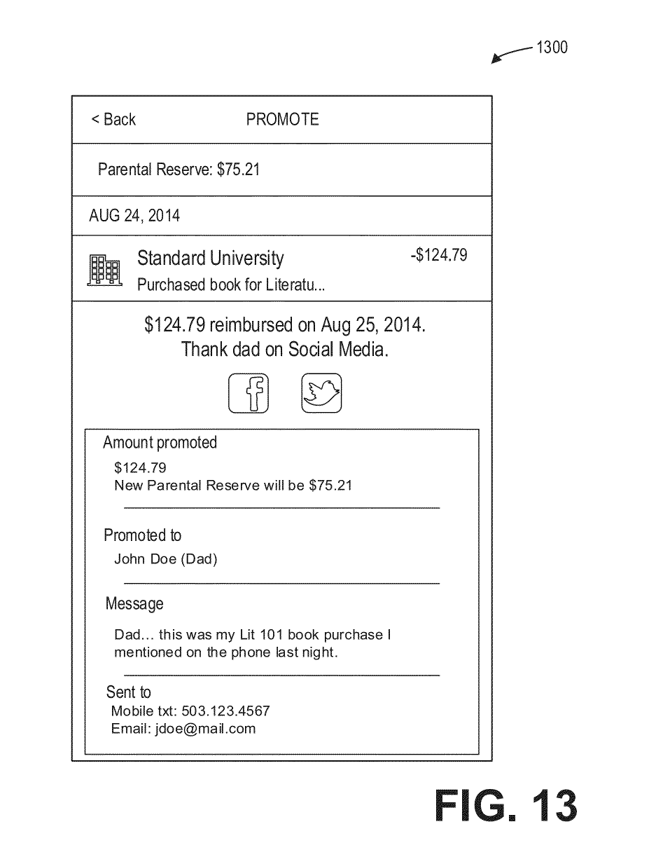

As described further herein, computing environment 100 enables a primary user of primary user device 111 to manage a primary bank account belonging to the primary user. For example, the primary user may use a bank card (not shown) associated with the primary bank account to purchase goods and services from a vendor. Meanwhile, server 101 may provide banking services regarding the primary bank account to the primary user. To that end, server 101 may provide interactive graphical user interfaces (GUIs) that include, as non-limiting examples, detailed transaction history, a current balance, messages regarding transactions and account management, and the like. As described further herein with regard to FIGS. 4-8, such GUIs may include one or more user inputs (e.g., buttons, checkboxes, text fields, etc.) that enable a primary user to select a transaction item for promotion to a secondary user of secondary user device 121. Furthermore, as described further herein with regard to FIGS. 13-14 and 17-19, such GUIs may further enable a primary user to view a decision made by the secondary user, and accordingly thank the secondary user if the decision is positive or re-promote the transaction item if the decision is negative.

Secondary user device 121 may comprise a computing device configured to display one or more user interfaces output by server 101. Additionally, secondary user device 121 may be further configured to transmit user input to server 101. As such, secondary user device 121 may include a processor 123, memory 124, display 125, and communication subsystem 126. Secondary user device 121 is shown in simplified form. However, secondary user device 121 may take the form of one or more personal computers, server computers, tablet computers, home entertainment computers, network computing devices, gaming devices, mobile computing devices, mobile communication devices (for example, smart phone, smart watch, etc.), and/or other computing devices.

In some embodiments, a secondary user of secondary user device 121 may access information regarding the primary bank account. For example, server 101 may provide secondary user device 121 with GUIs that display the current balance and the transaction history of the primary bank account.

However, in other embodiments, the secondary user of secondary user device 121 may be restricted to viewing portions of the transaction history that are selected by the primary user. For example, the primary user may select a purchase for promotion to the secondary user, whereupon the secondary user may select whether or not to reimburse the primary user for the purchase. To that end, server 101 may provide a GUI including recent transaction history to primary user device 111, primary user device 111 may transmit a selected transaction to server 101, server 101 may transmit a notification of the selection to the secondary user device 121, server 101 may provide upon request a GUI displaying the selected transaction to the secondary user device 121, the secondary user device 121 may transmit a decision to the server 101, and the server 101 may transmit a notification of the decision to the primary user device 101 while implementing the decision. For example, if the decision is affirmative, or the transaction is approved for reimbursement, then the server 101 may transmit an approval notification to the primary user device 101 while enacting a payment from the secondary user's bank account to the primary bank account.

In one embodiment, the primary user may use the bank card associated with the primary bank account for a broad range of activity including, but not limited to, using an ATM, depositing and withdrawing cash, making purchases, storing money for future use, and so on.

In some embodiments, the primary user and the secondary user may establish the primary bank account together, for example when the primary user is under a specified age such as eighteen years old. In such embodiments, the primary user and/or the secondary user may establish a reserve balance for the primary bank account. In particular, the reserve balance may comprise a pre-paid monetary value stored in the primary bank account that may be controlled by the secondary user. The reserve balance may comprise any monetary value. For example, the reserve balance may be two hundred dollars. In other examples, the reserve balance may be greater than or less than two hundred dollars.

An account balance of the primary bank account may not include the reserve balance. Thus, in some embodiments, the primary bank account may include a reserve balance in addition to a normal account balance, where the normal account balance may comprise a monetary amount available for spending by the primary user.

In one embodiment, the reserve balance may be utilized for reimbursing the primary user for a promoted transaction. For example, the primary user may promote any transaction to a secondary user for consideration of reimbursement by the secondary user. By accepting the promotion, the secondary user thereby agrees to transfer funds from a financial account belonging to the secondary user to the primary bank account of the primary user. However, such transfers between accounts may take 24-72 hours to complete. In order to rapidly reimburse the primary user upon acceptance of the promotion, the reimbursement amount may be transferred from the reserve balance to the normal balance. The funds transferred from the secondary financial account to the primary bank account may therefore be placed in the reserve balance. In this way, the primary user may be promptly reimbursed via the reserve balance while the transfer transaction is completed.

In some examples, the secondary user may control one or more properties of the reserve balance. For example, the secondary user may control an amount of money in the reserve balance. As another example, the secondary user may control whether or not the primary user may hold a “negative” balance (i.e., whether or not the primary user may utilize the reserve funds without pre-authorization). As yet another example, the secondary user may release money from the reserve to the primary user's accessible balance. As yet another example, the secondary user may enable automatic reimbursement to the primary user for specified purchases, vendors, amounts, and so on.

In one example, when the primary user and the secondary user establish the primary bank account, the secondary user may select the amount of funds he or she wishes to hold on reserve. The secondary user may select not to have a reserve, in which case the primary user must wait however long necessary for the transfer of money from the secondary user's financial account to the primary bank account to occur. The secondary user may change the reserve balance or increase the reserve balance by adding money to the reserve balance at any point. For example, the secondary user may choose to begin with a zero reserve balance, and then quickly come to understand the benefit to the reserve as the primary user begins spending with the banking card.

In some examples, the secondary user may pre-authorize the primary user to utilize funds in the reserve, thereby allowing the primary user to develop a negative account balance. For example, if the reserve balance is $200 and the account balance is $50, the primary bank account contains a total of $250. Without pre-authorization to utilize the reserve, the primary user may spend up to $50 before the banking card is declined due to lack of (accessible) funds in the account. In contrast, with pre-authorization to utilize the reserve, the primary user may spend up to $250 before the banking card is declined due to lack of funds in the account. In such an example, the account balance may display a negative balance despite the presence of funds in the reserve, in addition to the adjusted reserve balance. For example, if the primary user spends $75, the account balance may be negative (i.e., −$25) while the reserve balance may be adjusted to reflect the deficit (i.e., $175). In examples where the secondary user grants pre-authorization to access the reserve, the promotion engine 107 may transfer an amount equal to the deficit in the reserve balance from the secondary financial account to the primary bank account in order to replenish the reserve.

In some examples, the secondary user may grant a revocable pre-authorization to the primary user. For example, the secondary user may grant pre-authorization for the primary user to access the reserve funds based on responsible financial behavior demonstrated by the primary user. In some examples, the secondary user may receive a notification via secondary user device 121 indicating a transaction that has utilized reserve funds, and a GUI displayed on secondary user device 121 may enable the secondary user to approve or reject covering the transaction. In this way, the secondary user may reject a transaction that is covered at least in part by the reserve funds after the transaction is complete. The burden of replenishing the reserve is therefore on the primary user, who must personally reimburse the reserve before spending with the banking card.

As an illustrative and non-limiting example, the primary user may choose to spend $100 for entertainment purposes when the primary user has $25 in the normal account and $200 in the reserve, thereby spending $75 of the reserve funds. Promotion engine 107 may send a notification to the secondary user indicating that the primary user has accessed the reserve. In some examples, the notification may enable the secondary user to approve or reject the transaction. The secondary user may choose to reject the transaction if the secondary user determines such a transaction to be irresponsible. As a result, the promotion engine 107 may not transfer funds from the secondary financial account to the primary bank account. Instead, the primary account may include a negative balance of −$75. In order to resume using the banking card, the primary user may deposit at least $75 which may go directly to the reserve.

In examples wherein the secondary user is a parent and the primary user is a dependent child, the systems and methods herein may provide a practical financial literacy teaching aid. For example, there may be times when the child is running low on their own money and without the parent giving the option to access the reserve prior to the parent approving, the child simply may not be able to use the card product to purchase. If the child has shown responsibility this is likely an option that most parents would want to allow. If the parent were to disapprove after the fact, the child would be left with a negative balance and would be forced to essentially crawl back out of debt if poor decisions were ever made. From the parent's perspective, this is both a good teaching aid should it occur as well as something that still yields far better control than handing over the parent's credit card and hoping for the best. Optionally, the parent may only allow the child to first use their own money, and not have access to the reserve while purchasing. This likely limits how much they can spend, but the child will still receive the reimbursed funds immediately upon the parental approval of the promoted transaction.

In some examples, computing environment 100 may enable a quick transfer of funds between the secondary user and the primary user. Quick transfer comprises the secondary user allowing at least a portion of the reserve funds to be accessible to the primary user for at least a duration of time. Quick transfers may be used, for example, in situations wherein the secondary user does not generally pre-authorize use of the reserve funds. In one example, the primary user may request access to a certain amount of the reserve prior to making a transaction. If the secondary user approves the request, the amount requested may be available for use by the primary user. In some examples, the secondary user may specify a time duration that the amount of reserve funds may be available for use by the primary user. For example, the secondary user may specify that the amount requested is available for one hour, or may specify that the amount requested is available for a duration of time less than or equal to an hour. Furthermore, in some examples the secondary user may specify a specific merchant, category, location, and so on to impose an additional limitation on access to the reserve funds. In this way, the secondary user may grant pre-authorization for the primary user to utilize reserve funds with specific limitations in place to ensure that the primary user purchases the specific goods and/or services authorized by the secondary user.

In some examples, the secondary user may provide pre-authorization of certain merchants. For example, the secondary user may select particular merchants for whom a promoted transaction is automatically approved. In this way, the system depicted in FIG. 1 may streamline the reimbursement process.

In some examples, the reserve funds may comprise a line of credit. For example, if the secondary user chooses to not deposit funds into a reserve in the primary bank account, the secondary user may establish a line of credit on behalf of the primary user or may attach a credit card to the primary bank account to function as the reserve. The line of credit may be treated similarly to the reserve funds described hereinabove, and may be subject to additional fees (e.g., transaction fees, interest, etc.). In this way, the primary user may gain his or her first exposure to credit. In some examples, the primary user may optionally be able to start building credit at a very early age as a secondary on the line of credit. Such examples provide a controlled approach to providing credit to primary users.

In some examples, the access of secondary user may change based on an age of the primary user. For example, when the primary user is a dependent child under the age of 18, the secondary user (e.g., the parent of the primary user) may be the main account holder. In such examples, the secondary user, or parent, may have complete access to the primary bank account. When the age of the primary user is 18 or older, the primary user may become the main account holder, and may therefore control access for the secondary user. In some examples, the primary user may select from a few levels of account access to the secondary user. For example, the primary user may allow the secondary user to view promoted transactions, all transactions, or selected transactions. Further, the primary user may allow the secondary user to view the primary account balance, the reserve balance, a combination thereof, or no balance.

In some examples, promotion engine 107 may transmit notifications regarding a transaction upon completion of the transaction to the primary user device 111 and/or the secondary user device 121. Such notifications may comprise a push notification from an application, a text message, an email, and so on. In some examples, the primary user may select a time delay for sharing the transaction with the secondary user. Such time delays may comprise a duration of time before promotion engine 107 transmits a transaction notification to the secondary user device 121. For example, promotion engine 107 may transmit a transaction notification to primary user device 111 without a time delay and may subsequently transmit the transaction notification to secondary user device 121 with a time delay. In this way, the primary user may personally notify the secondary user of a transaction, thereby increasing direct communication between the primary user and the secondary user.

As a non-limiting illustrative example, the secondary user may be under the assumption that the primary user is dining at a particular restaurant with friends. However, the primary user and his or her friends may decide last-minute to dine at a different restaurant. The secondary user may become concerned responsive to reading a transaction notification on secondary user device 121 due to the original assumption. However, a time delay applied to the notification of the secondary user enables the primary user to directly communicate the change of plans to the secondary user after the transaction is complete and before the secondary user receives the transaction notification. Such communication may explain why the friends dined at a different restaurant. In some examples, the transaction notification transmitted to primary user device 111 may include a function facilitating such direct communication between the primary user and the secondary user. For example, the transaction notification may include a suggestion to communicate with a secondary user to explain the transaction. Furthermore, message module 240 may transmit a message from the primary user to the secondary user.

In some examples, the time delay applied to transmitting a transaction notification to the secondary user may enable a bundling of transaction notifications transmitted to the secondary user. For example, if the primary user conducts multiple transactions within a specified time duration, the secondary user may receive a single notification including details regarding the multiple transactions instead of a notification for each of the multiple transactions.

In some examples, the primary user may promote a transaction to a group of secondary users. In such examples, secondary user device 121 may comprise a plurality of secondary user devices 121. Each secondary user may contribute towards the reimbursement of the promoted transaction.

In some examples, the secondary user may deposit funds into the primary bank account and may pre-authorize use of the funds for one or more specific merchants and/or merchant categories. As a non-limiting illustrative example, the secondary user may deposit funds intended to pay for lunch, and so the secondary user may specify a specific cafeteria or a specific restaurant.

The systems and methods described herein enable a primary user, such as a dependent child, to promote a transaction to a secondary user, such as a parent. Furthermore, in examples where the primary bank account includes a reserve comprising funds deposited and controlled by the secondary user, the primary user may be promptly reimbursed for the transaction upon approval of the promoted transaction by the secondary user. That is, an amount specified for reimbursement by the secondary user may be released from the reserve into the primary bank account for immediate use by the primary user, while funds equal to the amount specified for reimbursement are transferred from the secondary user's bank account to the primary bank account. The transferred funds may be deposited directly into the reserve, thereby replenishing the reserve after reimbursement.

FIG. 2 shows a high-level block diagram illustrating an example computer architecture 200 according to an embodiment. In particular, architecture 200 relates to the structure of promotion engine 107, which may be implemented on server 101. As shown, promotion engine 107 may comprise a plurality of modules, each module configured to perform one or more tasks, such as an account controls module 210, an interface module 220, a promotion module 230, a message module 240, a transaction module 250, a balance module 260, a payment module 270, and so on. Each module may be communicatively coupled to each other module to perform the methods described herein. Furthermore, each module may be communicatively coupled to a corresponding database, where each database may be included in non-transitory memory in server 101 or may be remotely located.

Account controls module 210 may be configured to user accounts and profiles. For example, account controls module 210 may provide account registration services and handle account login authentication. In some examples, account controls module 210 may further connect user accounts with external social network logins. Account controls module 210 may be communicatively coupled to an account controls database 215.

Interface module 220 may provide user interface 227 for display on a user device, such as primary user device 111 as shown or a secondary user device 121. Example graphical user interfaces (GUIs) provided by interface module 220 are described further herein and with regard to FIGS. 4-19. Interface module 220 may be communicatively coupled to an interface database 225.

Promotion module 230 may handle sending a promoted transaction to a secondary user in addition to facilitating a decision regarding the promoted transaction. Promotion module 230 may be communicatively coupled to a promotion database 235, and may store current and historical information regarding promoted transactions in promotion database 235.

Message module 240 may handle messages between users, including via social networks. Message module 240 may further handle system messages to users. Message module 240 may be communicatively coupled to a message database 245.

Transaction module 250 may handle transactions for the primary bank account. For example, transaction module 250 may facilitate financial transactions between the primary bank account and a merchant account when the primary user purchases goods and/or services from a merchant. Transaction module 250 may be communicatively coupled to a transaction database 255.

Balance module 260 may handle account balances including, but not limited to, a normal account balance and a reserve balance. For example, balance module 260 may provide current and historical account balances and reserve balances. In one example, balance module 260 may update an account balance and a reserve balance responsive to a secondary user approving a promoted transaction. For example, if a secondary user approves a promoted transaction for a specified amount, balance module 260 may decrease the reserve balance by the specified amount and increase the normal account balance by the specified amount. Upon successful transfer from a financial account belonging to the secondary user to the primary bank account, balance module 260 may update the reserve balance to reflect the reimbursement. Balance module 260 may be communicatively coupled to a balance database 265.

Payment module 270 may facilitate the transferal of funds from one account to another account. For example, when a secondary user approves a promoted transaction, payment module 270 may schedule and facilitate the transfer of funds from an account belonging to the secondary user to an account belonging to the primary user. As such, payment module 270 may interface with balance module 260 to provide updated account balances. Payment module 270 may be communicatively coupled to a payment database 275.

FIG. 3 shows a high-level flow chart illustrating an example method 300 for promoting purchased items to a target user according to an embodiment. In particular, method 300 relates to the promotion of a purchased item by a primary user to a target user, and a subsequent decision by the target user. Method 300 may be described with reference to the components and systems depicted in FIGS. 1 and 2, however a person skilled in the art with the benefit of this disclosure will readily appreciate that the method may be applied to different components and systems without departing from the scope of the present disclosure. Specifically, method 300 may be carried out by promotion engine 107 of server 101 and may be stored as executable instructions in non-transitory memory thereon.

Method 300 may begin at 305. At 305, method 300 may include evaluating a user account status regarding the primary user. Evaluating a user account status may include, for example, determining a current account balance, a reserve balance, transaction history, and so on.

At 310, method 300 may include receiving a promotion selection from the primary user. A promotion selection may comprise a selected transaction item in the transaction history. The promotion selection may further comprise a selected target user (e.g., a secondary user), a monetary amount for promotion, one or more photographs, and a personalized message to the target user.

The target user may be selected from a list of people. In one example, the target user may be selected from an approved list of people. For example, the approved list of people may include one or more family members. In some examples, a parent or guardian of the primary user may approve the list of people available for selection. In another example, the list of people may comprise a list of people specified upon establishing the user account. In some examples, the primary user may add one or more people to the list of people. In such examples, the primary user may add the one or more people from the primary user's friend list on a social media platform, for example, or the primary user may add a person by submitting contact information for the person, such as name, email, phone number, and so on. Furthermore, in some examples the primary user may select one or more target users. In such examples, the primary user may create groups of target users and assign a name to each group. For example, one group may comprise grandparents of the primary user, and the primary user may thus name the group “Grandparents” to easily identify the group. In such an example, the primary user may select the group of target users, who may each receive the promotion selection.

The primary user may specify a monetary amount for promotion. In particular, the monetary amount specified for promotion comprises an amount the primary user would like to be reimbursed by the target user. In one example, the primary user may input a monetary amount equal to or less than the total amount of the selected transaction. In another example, the primary user may input a monetary amount greater than the total amount of the selected transaction.

The primary user may provide photographs, for example, to authenticate the purchase for the target user. For example, the primary user may provide photographs of a purchased good or the primary user enjoying a purchased service. In some examples, the primary user may choose to not upload a photograph.

The primary user may provide a personalized message for the target user. The personalized message may comprise any text input by the primary user. For example, the personalized message may contextualize the promotion or give thanks in advance for the target user accepting the promotion. In some examples, the primary user may choose to not provide a personalized message.

At 315, method 300 may include sending a promotion notification to a target user. The promotion notification may comprise any method of digitally messaging a person. For example, the promotion notification may comprise a push notification from a mobile phone application, a text message, an email, and so on. The promotion notification may comprise a message notifying the target user that the primary user has promoted a transaction to the target user for reimbursement.

At 320, method 300 may include determining if the target user is registered. If the target user is not registered, method 300 may proceed to 325. At 325, method 300 may include registering the target user. If the target user is registered, method 300 may proceed to 330. At 330, method 300 may include receiving the target user login information.

After receiving the login information at 330 or the registration information at 325, method 300 may proceed to 335. At 335, method 300 may include displaying the promotion selection to the target user. The displayed promotion selection may include, but is not limited to, transaction details, a monetary amount for reimbursement, photographs, the personalized message, and so on. In some examples, the displayed promotion selection may include the one or more selected target users. In other examples, the displayed promotion selection may not include the one or more selected target users.

In particular, server 101 may provide a GUI to secondary user device 121, the GUI including the promotion selection details and enabling the one or more target users to approve or disapprove the promotion. At 340, method 300 may include receiving a decision from the target user. The decision may comprise an approval or a disapproval of the promotion. The decision may further include an amount specified by the target user for reimbursement. For example, the target user may specify an amount to reimburse the primary user. The specified amount may be equal to the amount requested by the primary user, or may be less than or greater than the amount requested. The decision may even further include a personalized message from the target user to the primary user. The decision may further include a selected target financial account belonging to the target user. For example, the target user may select to reimburse the primary user using funds from a checking account, a savings account, a credit card, and so on.

At 345, method 300 may include determining if the promotion is approved. If the promotion is approved, method 300 may proceed to 350. At 350, method 300 may include transferring funds from the target user's financial account to the primary user's bank account.

At 355, method 300 may include updating user account information. Updating user account information may comprise, for example, updating the account balance, updating the reserve balance, updating a promotion status regarding the promotion of a selected transaction, and so on.

At 360, method 300 may include notifying the user of the approval. Notifying the primary user of the approval may comprise sending a push notification to the primary user on primary user device 111, sending an email to the primary user, sending a text message to the primary user, sending a message to the primary user via message module 240, and so on. Method 300 may then end.

Returning to 345, if the promotion is declined, method 300 may proceed to 365. At 365, method 300 may include notifying the user of the rejection. Notifying the primary user of the rejection may comprise sending a push notification to the primary user on primary user device 111, sending an email to the primary user, sending a text message to the primary user, sending a message to the primary user via message module 240, and so on. Method 300 may then end.

As a non-limiting illustrative example, consider a scenario in which the secondary user is a parent and the primary user is a dependent child of the parent. First, the child makes a purchase using his or her banking card. The child may be notified via his or her mobile device (e.g., push notification, text message, email, etc.) of the success of the purchase, and at that time may be given the option to promote the cost of that purchase towards the parent. If the child chooses to promote the purchase, the parent may in turn receive a notification of that purchase and the child's promotion of the purchase, or request for reimbursement. The parent will see all of the details of the purchase (e.g., where, when, amount, etc.) as well as any notes or photographs the child provides for the parent regarding the transaction. When the parent decides to (1) accept the promoted payment and reimburse for the full amount, (2) accept and reimburse for a partial amount, or (3) decline the promoted payment, the child is then notified of the parent's decision via his or her mobile device. If the promoted amount was accepted for reimbursement, the parent will cover that cost, and thus a transfer of funds will occur between the parent's selected banking account and the child's bank account. If the parent has not yet connected their banking details to this account at an earlier time they will be given the option to do so.

As described further herein, FIGS. 4-19 illustrate graphical user interfaces (GUIs) that may be displayed to a primary user and a secondary user via primary user device 111 and secondary user device 121, respectively. While the examples herein below depict the primary user as a child and the secondary user as a mother or father of the child, it should be understood that the interfaces, methods, and systems described herein may be utilized by any primary-secondary relationship.

FIG. 4 illustrates an example graphical user interface 400 providing a user account dashboard according to an embodiment. GUI 400 may be transmitted from promotion engine 107 of server 101 to primary user device 111 via network 130, for example, and may be displayed via display 115. As described further herein, GUI 400 may include one or more buttons configured to transmit information to promotion engine 107 of server 101 via network 130 or to display a different GUI.

GUI 400 may include an overview of a current account status for a primary user. As depicted, GUI 400 may include a current account balance, current reserve balance, current promoted amount awaiting a decision, and one or more recent transaction overviews. In some examples, GUI 400 may display a virtual banking card with the primary user's name and the card provider, and the current account balance may be displayed thereon as depicted.

Each recent transaction overview may include the vendor name and associated details, an icon depicting a category for the transaction and/or vendor, an icon providing a link to a notepad wherein the primary user may input a note regarding the transaction, and an amount debited or credited to the primary bank account by the transaction. The transaction overview may further include a promote button configured to display whether or not the transaction is selected for promotion and further configured to promote the transaction responsive to the primary user selecting the promote button.

As depicted, some transactions may comprise the transfer of funds to another user. For example, the primary user may send money to another person using the promotion platform. The corresponding transaction overview may thus include the name and contact information of the person to whom the funds were sent (e.g., the name of the recipient “John Q Public” and the recipient's phone number). Such transactions may also be promoted to a secondary user. In one example, such as the illustrated GUI 400, a user may promote to a merchant (such as University Café) or to another user (such as John Public) through the promotion platform.

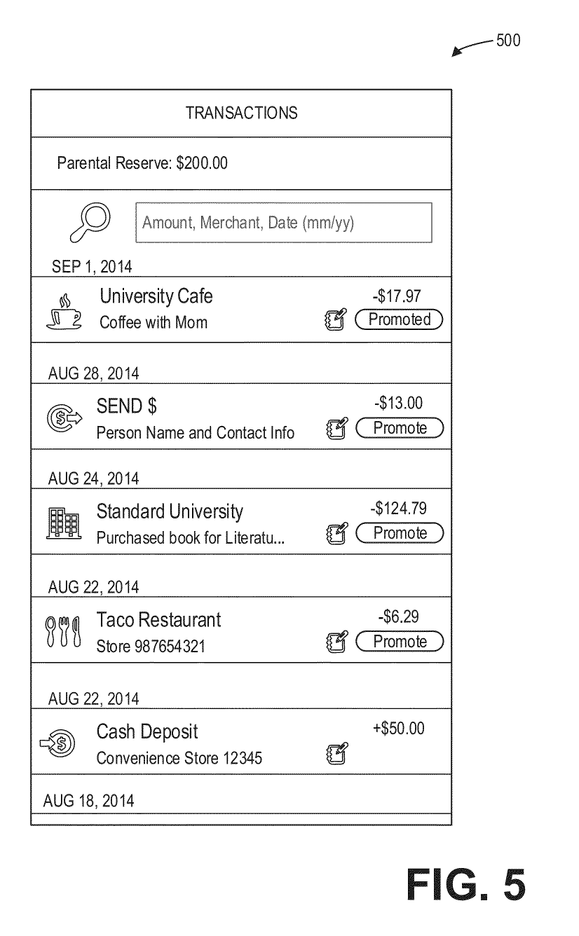

GUI 400 may further include a button configured to display a separate GUI including all transactions responsive to the primary user selecting the button. In particular, the example graphical user interface 500 depicted in FIG. 5 provides an overview of all transactions according to an embodiment. GUI 500 may be transmitted from promotion engine 107 of server 101 to primary user device 111 via network 130, for example, and may be displayed via display 115. As described further herein, GUI 500 may include one or more buttons configured to transmit information to promotion engine 107 of server 101 via network 130 or to display a different GUI.

GUI 500 may include a list of individual transaction overviews. As described hereinabove with regard to FIG. 4, each transaction overview may include the merchant name and associated details, an icon depicting a category for the transaction and/or merchant, an icon providing a link to a notepad wherein the primary user may input a note regarding the transaction, an amount debited or credited to the primary bank account by the transaction, and a promote button configured to display whether or not the transaction is selected for promotion and further configured to promote the transaction responsive to the primary user selecting the promote button.

GUI 500 may include a text input enabling the primary user to search transactions by amount, merchant, date, and so on. GUI 500 may further display a current account balance and/or a reserve balance.

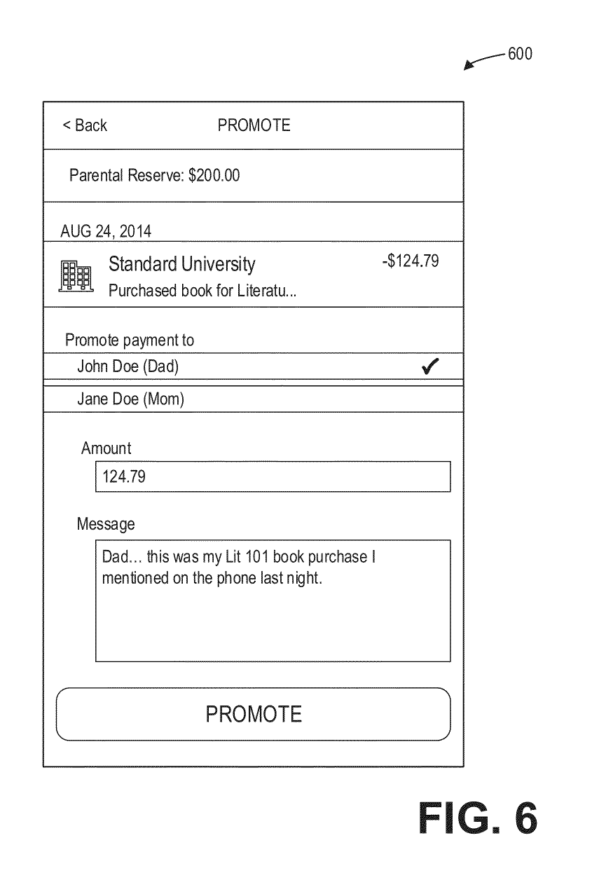

FIG. 6 illustrates an example graphical user interface 600 for promoting a purchased item to a target user according to an embodiment. In particular, GUI 600 may be displayed to a primary user upon selecting a transaction item for promotion via the promote button depicted in FIGS. 4 and 5. GUI 600 may be transmitted from promotion engine 107 of server 101 to primary user device 111 via network 130, for example, and may be displayed via display 115. As described further herein, GUI 600 may include one or more buttons configured to transmit information to promotion engine 107 of server 101 via network 130 or to display a different GUI.

GUI 600 may include details regarding the selected transaction, a list including one or more selectable target users, a text input for inputting an amount for promotion, and a text input for a personalized message. GUI 600 may optionally include a function to upload one or more photographs to send to the selected target user. GUI 600 may further display a current reserve balance. GUI 600 may further include a promote button configured to prepare the promotion upon selection of the promote button by the primary user.

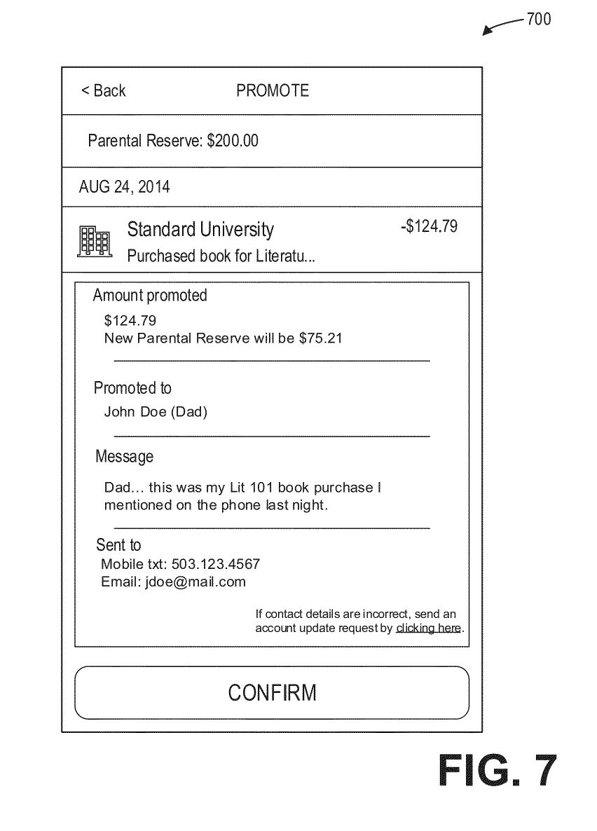

FIG. 7 illustrates an example graphical user interface 700 enabling user confirmation of a promotion to a target user according to an embodiment. In particular, GUI 700 may display the promotion selection as input via GUI 600 in addition to a confirm button, the confirm button configured to finalize the promotion and send the promotion selection to the selected target user. GUI 700 may include contact information such as phone number and email for the selected target user, and may further include an option to edit the contact information. GUI 700 may further display an updated reserve balance comprising the reserve balance upon the target user accepting the promotion.

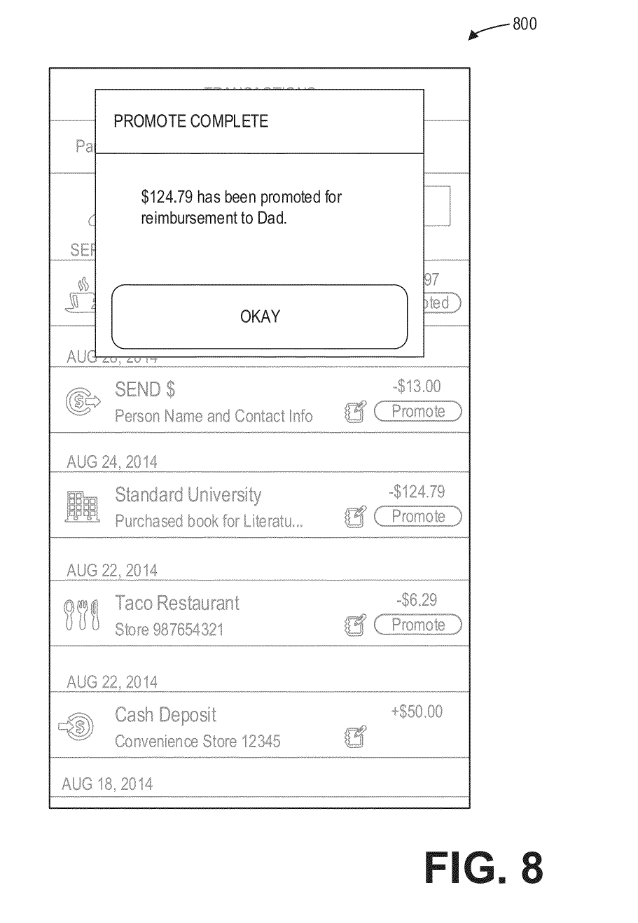

After the primary user reviews the promotion selection and selects the confirm button, primary user device 111 may display the example graphical user interface 800 depicted in FIG. 8. GUI 800 may display a confirmation that the promotion selection is successful and is being transmitted to the target user.

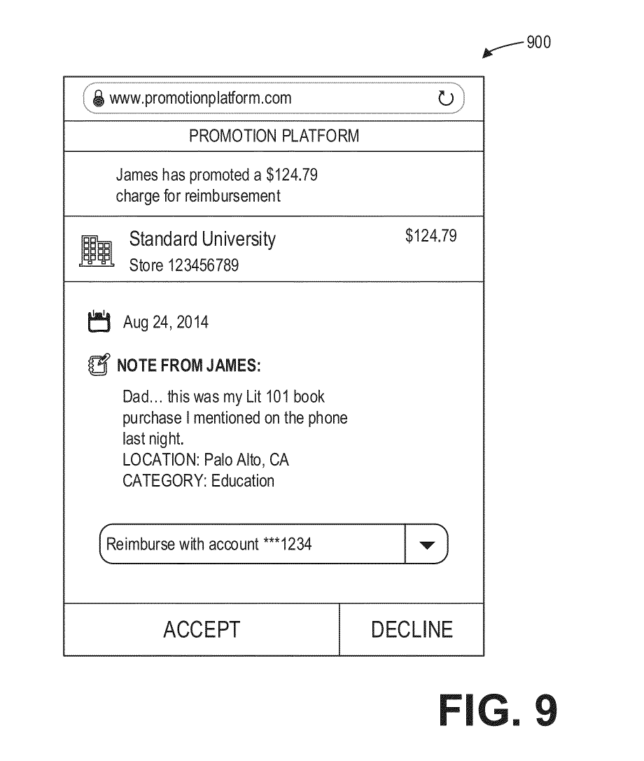

After the promotion selection is confirmed, the target user may receive a notification that the primary user has promoted a transaction to the target user. The notification may comprise a push notification on secondary user device 121, an email, a text message to secondary user device 121, and so on. In one example, the notification may include a link to an application on secondary user device 121. In another example, the notification may include a link to a secure webpage containing the promotion selection, as depicted in FIGS. 9-12.

FIG. 9 illustrates an example graphical user interface 900 providing an individual promotion overview for a target user according to an embodiment. In particular, GUI 900 may be displayed on secondary user device 121.

GUI 900 may include information regarding the transaction such as merchant name and location, the total amount of the transaction, an amount requested for reimbursement, the date of the promotion, a personalized message from the primary user, the category of the transaction, an icon corresponding to the category of the transaction, and so on. GUI 900 may further include a menu for selecting at least one financial account belonging to the target user for reimbursing the primary user. GUI 900 may further include an accept button and a decline button, wherein the accept button is configured to accept the promotion upon selection by the target user and the decline button is configured to decline the promotion upon selection by the target user.

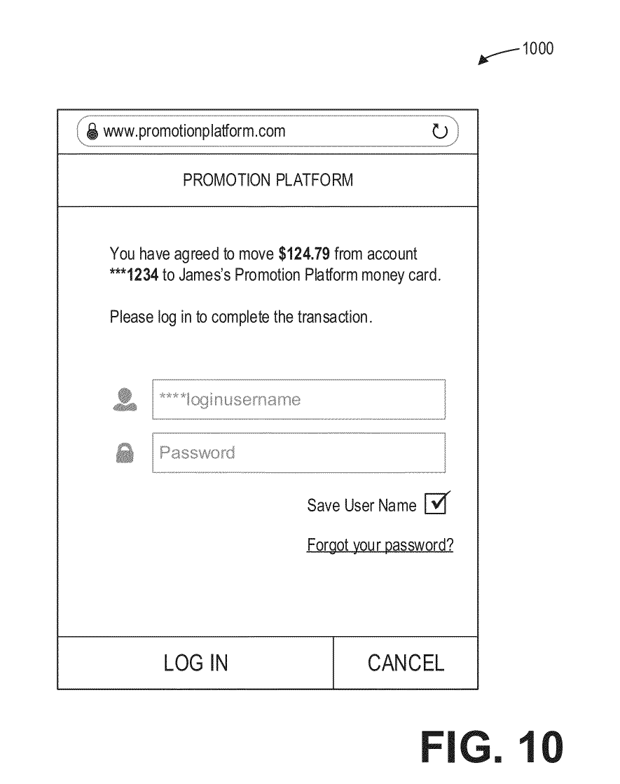

FIG. 10 illustrates an example graphical user interface 1000 for a target user log-in screen according to an embodiment. In particular, GUI 1000 may be displayed to the target user via secondary user device 121 responsive to the target user selecting the accept button depicted in GUI 900. GUI 1000 may comprise a login page for the target user, and as such may include one or more text inputs for a user name and/or a user password. In this way, the promotion may be securely confirmed by the target user.

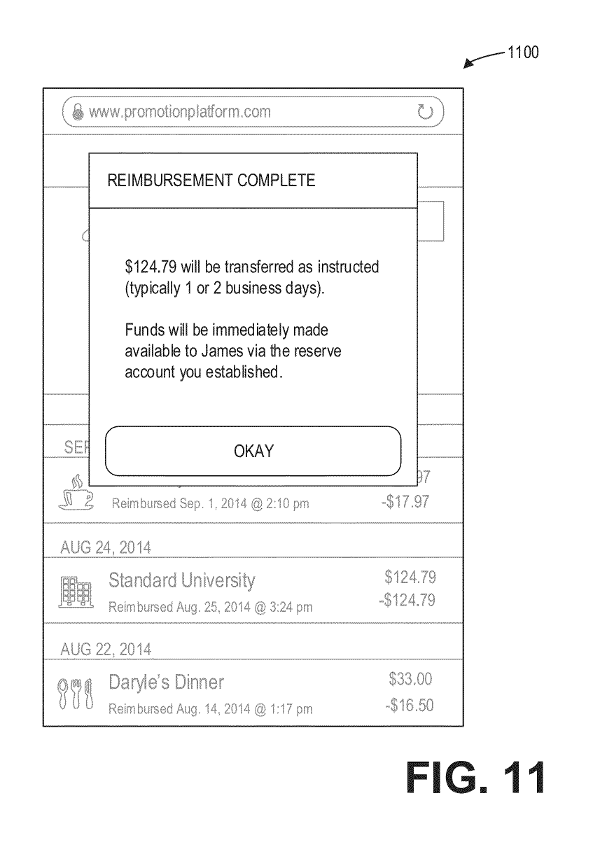

FIG. 11 illustrates an example graphical user interface 1100 for confirming an approved promotion according to an embodiment. In particular, GUI 1100 displays a text box indicating a successful promotion to a target user after the target user logs in to the account.

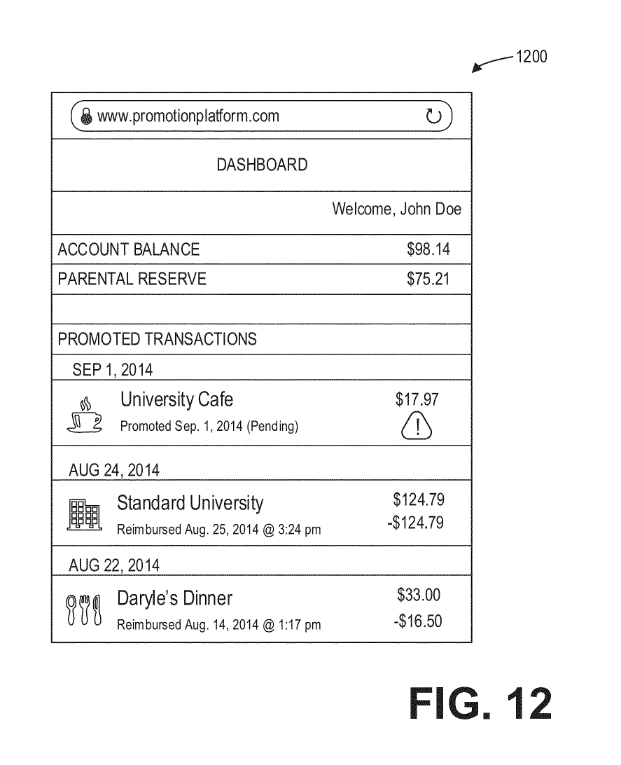

FIG. 12 illustrates an example graphical user interface 1200 for a dashboard overview of reimbursements for a target user according to an embodiment. In particular, GUI 1200 enables a target user, or a secondary user of secondary user device 121, to view details regarding promoted transactions and the primary bank account. For example, GUI 1200 may display the current account balance and the current reserve balance for the primary bank account.

GUI 1200 may further display a list of recent promoted transactions. As depicted, GUI 1200 may display pending promoted transactions and completed promoted transactions. GUI 1200 may display an amount requested for each promotion and an amount reimbursed for each promotion.

FIG. 13 illustrates an example graphical user interface 1300 for receiving a reimbursement from a secondary user according to an embodiment. In particular, GUI 1300 displays an overview of an accepted promotion, and may be displayed on primary user device 111.

GUI 1300 may include details of the promotion, including the amount promoted, the reserve balance after acceptance of the promotion, the target user to whom the promotion was sent, a personalized message from the target user regarding the promotion, and contact information for the target user.

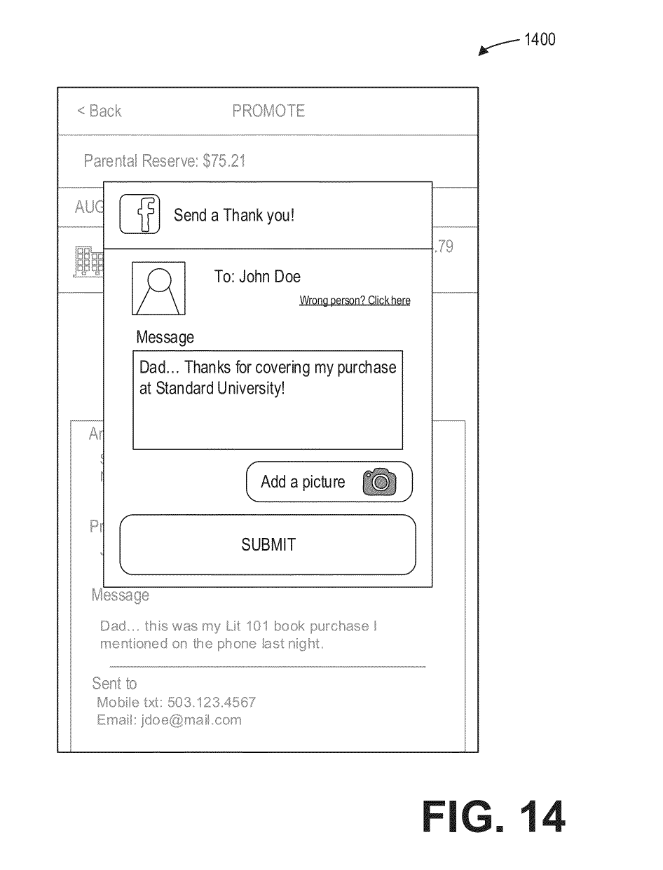

In some examples, GUI 1300 may enable the primary user to thank the target user for accepting the promotion via social media platforms including, but not limited to, FACEBOOK and TWITTER. For example, FIG. 14 illustrates an example graphical user interface 1400 for thanking a secondary user for a reimbursement according to an embodiment. In particular, GUI 1400 may enable the primary user to send a private or public message to the target user on a social media platform. As such, GUI 1400 may enable the primary user to include a textual message, and one or more photographs.

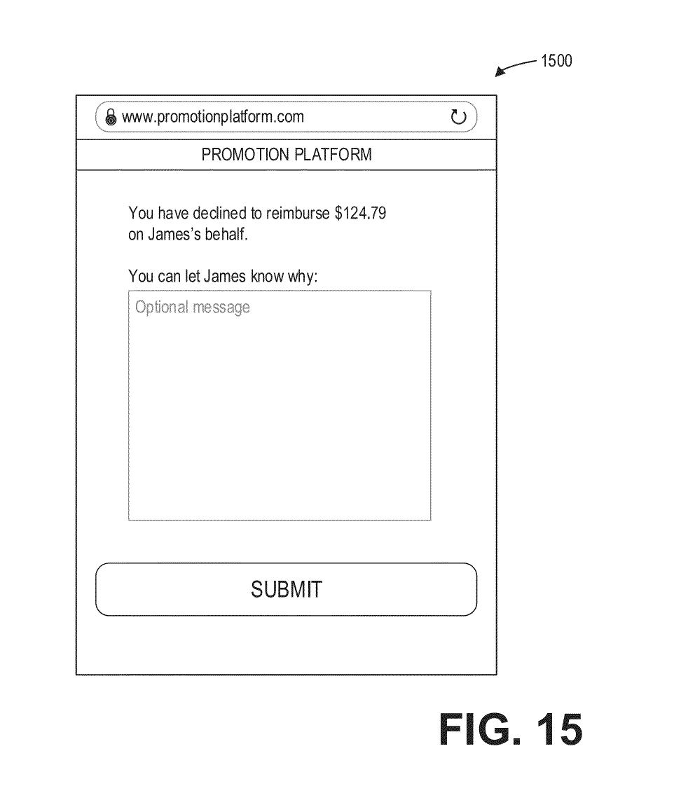

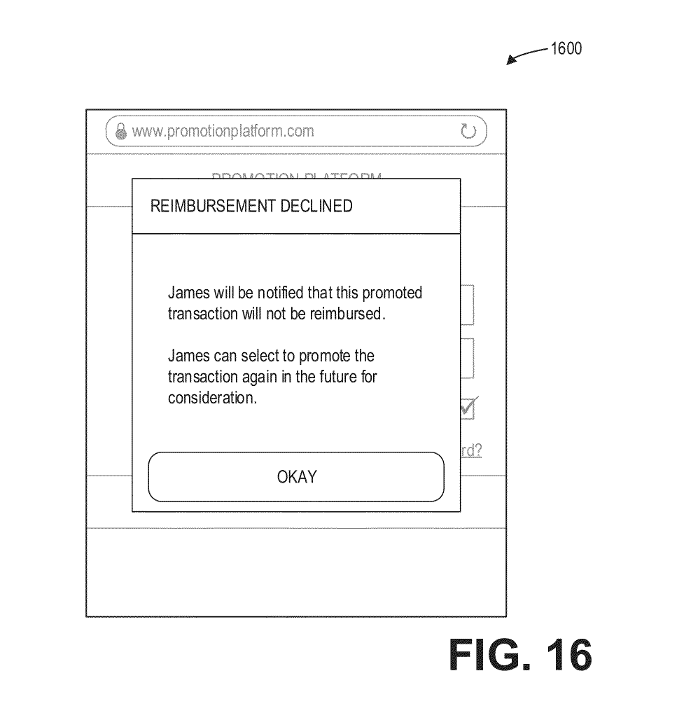

FIG. 15 illustrates an example graphical user interface 1500 for a secondary user declining a promoted item according to an embodiment. In particular, GUI 1500 comprises an example GUI displayed responsive to the target user selecting the decline button on GUI 900 depicted in FIG. 9. GUI 1500 may include a text input thereby enabling the target user to provide an optional message to the primary user explaining why the promotion is declined. After the target user selects the submit button, GUI 1600 depicted in FIG. 16 may be displayed to the target user. GUI 1600 comprises a confirmation that the promotion is declined, and may indicate that the primary user may promote the transaction again in the future.

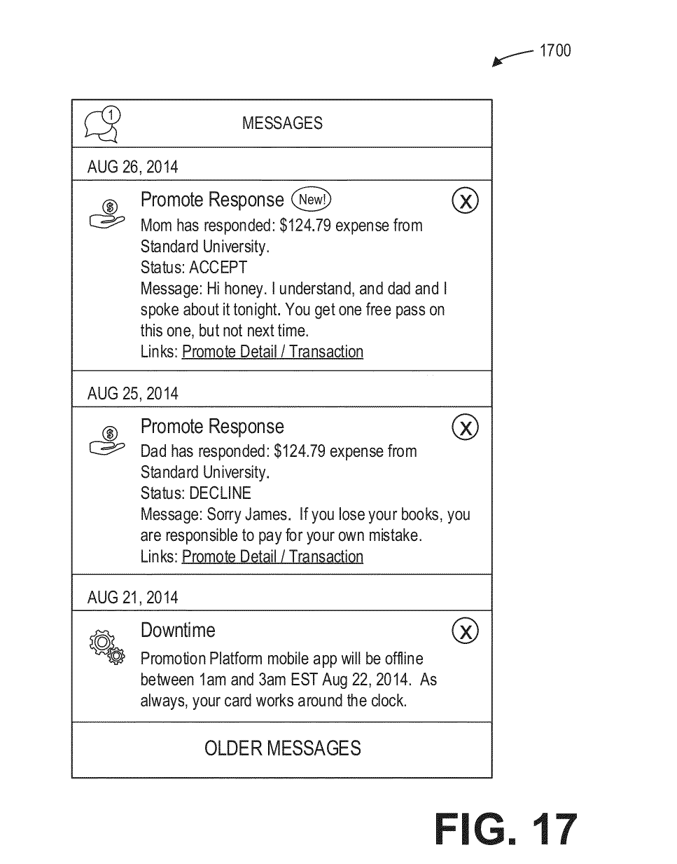

FIG. 17 illustrates an example graphical user interface 1700 for a messaging system according to an embodiment. GUI 1700 comprises a message center for the primary user, and therefore may include, as non-limiting examples, messages regarding promotions, transactions, and system maintenance.

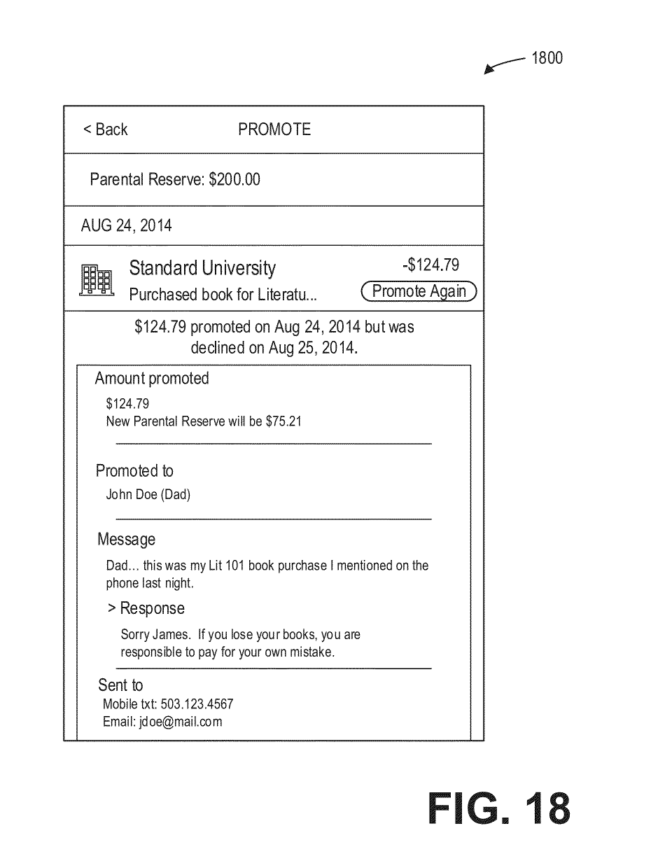

FIG. 18 illustrates an example graphical user interface 1800 providing details regarding a declined promotion according to an embodiment. In particular, GUI 1800 displays an overview of a declined promotion and may be displayed on primary user device 111. As such, GUI 1800 may include the original promotion selection in addition to a response from the originally selected target user. GUI 1800 may further include a button configured to promote the transaction again.

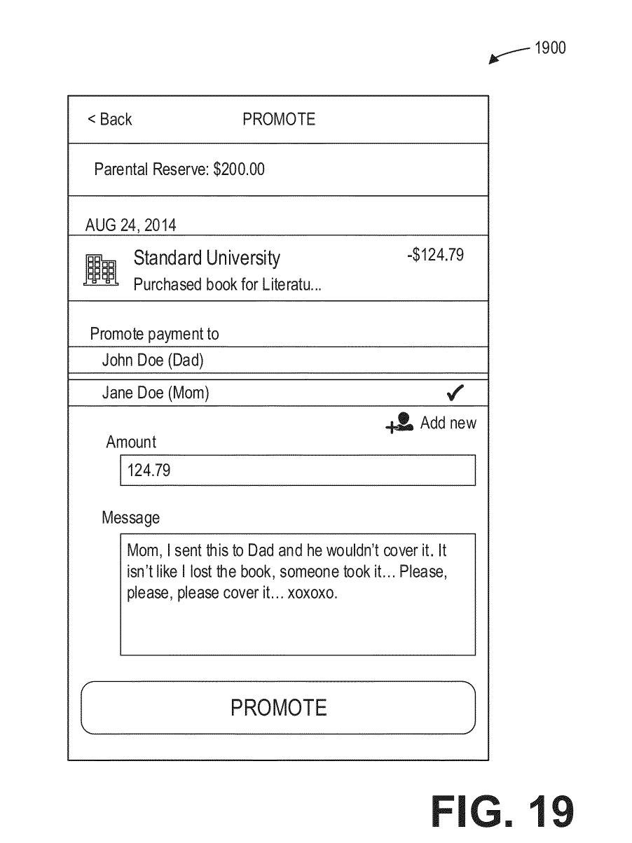

FIG. 19 illustrates an example graphical user interface 1900 for re-promoting a purchased item to a secondary user according to an embodiment. GUI 1900 enables the primary user to select a new target user, including the originally selected target user. GUI 1900 may further include a button configured to add new target users to the list.

It should be appreciated that the apparatuses, methods, and systems for facilitating reimbursement described herein provide substantial advantages over pre-existing technologies and methods. For example, users can be instantly reimbursed for approved transactions without waiting for funds to be transferred from one financial account to another. Further, the systems described herein provide varying degrees of control over an account to different users.

In one embodiment, an apparatus comprises: a server providing a promotion engine that is accessible to a plurality of users through a plurality of client systems communicatively coupled to the server via a network; and a data storage system storing a transaction database that is maintained by the server, the transaction database comprising a plurality of transaction records respectively associated with a plurality of transactions, each transaction record comprising an indication of a merchant of a transaction and a transaction amount paid to the merchant in the transaction; and wherein, upon being accessed by a user of a first client system of the plurality of client systems, the promotion engine is operable to receive an indication from the first client system of a selected transaction being selected from the plurality of transactions for promotion by the user; wherein, upon receiving promotion information specifying a target user of a second client system of the plurality of client systems from the first client system, the promotion engine is operable to transmit a request to the second client system for reimbursement for the selected transaction, the request including a reimbursement amount included in the promotion information and the indication of the merchant and the transaction amount paid to the merchant included in the transaction record associated with the selected transaction; and wherein, upon receiving approval of the request from the second client system, the promotion engine is operable to: update an account balance and a reserve balance stored within a balance database that is maintained within the data storage system by the server based on the reimbursement amount, the account balance comprising funds in an account associated with the user that are accessible to the user and the reserve balance comprising funds in the account that are inaccessible to the user; and transmit the updated account balance and the updated reserve balance to the first client system for rendering a current balance of the account within a user interface implemented at the first client system that specifies the updated account balance and the updated reserve balance.

In a first example of the apparatus, updating the account balance and the reserve balance based on the reimbursement amount comprises increasing the account balance by the reimbursement amount and decreasing the reserve balance by the reimbursement amount. In a second example of the apparatus optionally including the first example, upon receiving disapproval of the request from the client system, the promotion engine is operable to transmit a notification of the disapproval to the first client device. In a third example of the apparatus optionally including one or more of the first and second examples, after transmitting the request to the second client system and before receiving the approval, the promotion engine is operable to transmit pending balance information to the first client system for rendering within the user interface that specifies a pending account balance and a pending reserve balance based on the reimbursement amount. In a fourth example of the apparatus optionally including one or more of the first through third examples, the request further includes one or more of a message and an image input at the first client device. In a fifth example of the apparatus optionally including one or more of the first through fourth examples, upon receiving an indication of a pre-approved merchant from the second client device, the promotion engine is operable to automatically approve a request including an indication of the pre-approved merchant. In a sixth example of the apparatus optionally including one or more of the first through fifth examples, the approval of the request includes an approved reimbursement amount not equal to the reimbursement amount, and wherein the updating of the account balance and the reserve balance is based on the approved reimbursement amount.

In a seventh example of the apparatus optionally including one or more of the first through sixth examples, upon receiving the approval of the request from the second client device, the promotion engine is further operable to issue a request to a funding source associated with the target user for a transfer of funds corresponding to the reimbursement amount to the account. In this way, the reserve balance can be replenished by the target user using pre-existing methods (e.g., transferring funds between financial accounts), which typically require one to three business days, while the user is promptly reimbursed via the reserve balance in the meantime.

In another embodiment, a method comprises: providing, at a server, a promotion engine that is accessible to a plurality of users through a plurality of client systems communicatively coupled to the server via a network; maintaining, in a data storage system, a transaction database comprising a plurality of transaction records respectively associated with a plurality of transactions, each transaction record comprising an indication of a merchant of a transaction and a transaction amount paid to the merchant in the transaction; receiving, from a first client system of the plurality of client systems being operated by a user to access the promotion engine, promotion information comprising an indication of a selected transaction being selected from the plurality of transactions for promotion by the user, a reimbursement amount, and a target user of a second client system of the plurality of client systems; transmitting a request to the second client system for reimbursement for the selected transaction, the request including the reimbursement amount included in the promotion information and the indication of the merchant and the transaction amount paid to the merchant included in the transaction record associated with the selected transaction; and responsive to receiving approval of the request from the second client system: updating an account balance and a reserve balance stored within a balance database that is maintained within the data storage system by the server based on the reimbursement amount, the account balance comprising funds in an account associated with the user that are accessible to the user and the reserve balance comprising funds in the account that are inaccessible to the user; and transmitting the updated account balance and the updated reserve balance to the first client system for rendering a current balance of the account within a user interface implemented at the first client system that specifies the updated account balance and the updated reserve balance.

In a first example of the method, updating the account balance and the reserve balance based on the reimbursement amount comprises increasing the account balance by the reimbursement amount and decreasing the reserve balance by the reimbursement amount. In a second example of the method optionally including the first example, the method further comprises, upon receiving disapproval of the request from the client system, transmitting a notification of the disapproval to the first client device. In a third example of the method optionally including one or more of the first and second examples, the method further comprises, after transmitting the request to the second client system and before receiving the approval, transmitting pending balance information generated based on the reimbursement amount to the first client system for rendering a pending account balance and a pending reserve balance within the user interface. In a fourth example of the method optionally including one or more of the first through third examples, the request further includes one or more of a message and an image input at the first client device. In a fifth example of the method optionally including one or more of the first through fourth examples, the method further comprises receiving an indication of a pre-approved merchant from the second client device, and automatically approving a request including an indication of the pre-approved merchant. In a sixth example of the method optionally including one or more of the first through fifth examples, the approval of the request includes an approved reimbursement amount not equal to the reimbursement amount, and the updating of the account balance and the reserve balance is based on the approved reimbursement amount.

In yet another embodiment, a system comprises: a server providing a promotion engine; a plurality of client systems configured to communicatively couple to the server via a network to access the promotion engine; and a data storage system storing a transaction database comprising a plurality of transaction records respectively associated with a plurality of transactions, each transaction record comprising an indication of a merchant of a transaction and a transaction amount paid to the merchant in the transaction; wherein, upon being accessed by a user through operation of a first client system of the plurality of client systems, the promotion engine is operable to receive an indication from the first client system of a selected transaction being selected from the plurality of transactions for promotion by the user; wherein, upon receiving promotion information specifying a target user of a second client system of the plurality of client systems from the first client system, the promotion engine is operable to transmit a request to the second client system for reimbursement for the selected transaction, the request including a reimbursement amount included in the promotion information and the indication of the merchant and the transaction amount paid to the merchant included in the transaction record associated with the selected transaction; and wherein, upon receiving approval of the request from the second client system, the promotion engine is operable to: update an account balance and a reserve balance stored within a balance database that is maintained within the data storage system by the server based on the reimbursement amount, the account balance comprising funds in an account associated with the user that are accessible to the user and the reserve balance comprising funds in the account that are inaccessible to the user; and transmit the updated account balance and the updated reserve balance to the first client system for rendering a current balance of the account within a user interface implemented at the first client system that specifies the updated account balance and the updated reserve balance.

In a first example of the system, updating the account balance and the reserve balance based on the reimbursement amount comprises increasing the account balance by the reimbursement amount and decreasing the reserve balance by the reimbursement amount. In a second example of the system optionally including the first example, upon receiving disapproval of the request from the client system, the promotion engine is operable to transmit a notification of the disapproval to the first client device. In a third example of the system optionally including one or more of the first and second examples, after transmitting the request to the second client system and before receiving the approval, the promotion engine is operable to transmit pending balance information to the first client system for rendering within the user interface that specifies a pending account balance and a pending reserve balance based on the reimbursement amount. In a fourth example of the system optionally including one or more of the first through third examples, the request further includes one or more of a message and an image input at the first client device. In a fifth example of the system optionally including one or more of the first through fourth examples, upon receiving an indication of a pre-approved merchant from the second client device, the promotion engine is operable to automatically approve a request including an indication of the pre-approved merchant.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

Embodiments of a reimbursement system have been described. The following claims are directed to said embodiments, but do not preempt the reimbursement in the abstract. Those having skill in the art will recognize numerous other approaches to reimbursement are possible and/or utilized commercially, precluding any possibility of preemption in the abstract. However, the claimed system improves, in one or more specific ways, the operation of a machine system for reimbursing a user, and thus distinguishes from other approaches to the same problem in how its physical arrangement of a machine system determines the system's operation and ultimate effects on the material environment.

1. An apparatus, comprising:
a server providing a promotion engine that is accessible to a plurality of users through a plurality of client systems communicatively coupled to the server via a network; and
a data storage system storing a transaction database that is maintained by the server, the transaction database comprising a plurality of transaction records respectively associated with a plurality of transactions, each transaction record comprising an indication of a merchant of a transaction and a transaction amount paid to the merchant in the transaction, and
wherein, upon being accessed by a user of a first client system of the plurality of client systems, the promotion engine is operable to receive an indication from the first client system of a selected transaction being selected from the plurality of transactions for promotion by the user,
wherein, upon receiving promotion information specifying a target user of a second client system of the plurality of client systems from the first client system, the promotion engine is operable to transmit a request to the second client system for reimbursement for the selected transaction, the request including a reimbursement amount included in the promotion information and the indication of the merchant and the transaction amount paid to the merchant included in the transaction record associated with the selected transaction, and
wherein, upon receiving approval of the request from the second client system, the promotion engine is operable to:
update an account balance and a reserve balance stored within a balance database that is maintained within the data storage system by the server based on the reimbursement amount, the account balance comprising funds in an account associated with the user that are accessible to the user and the reserve balance comprising funds in the account that are inaccessible to the user; and
transmit the updated account balance and the updated reserve balance to the first client system for rendering a current balance of the account within a user interface implemented at the first client system that specifies the updated account balance and the updated reserve balance.

2. The apparatus of claim 1, wherein updating the account balance and the reserve balance based on the reimbursement amount comprises increasing the account balance by the reimbursement amount and decreasing the reserve balance by the reimbursement amount.

3. The apparatus of claim 1, wherein, upon receiving disapproval of the request from the client system, the promotion engine is operable to transmit a notification of the disapproval to the first client device.

4. The apparatus of claim 1, wherein after transmitting the request to the second client system and before receiving the approval, the promotion engine is operable to transmit pending balance information to the first client system for rendering within the user interface that specifies a pending account balance and a pending reserve balance based on the reimbursement amount.

5. The apparatus of claim 1, wherein, upon receiving the approval of the request from the second client device, the promotion engine is operable to issue a request to a funding source associated with the target user for a transfer of funds corresponding to the reimbursement amount to the account.

6. The apparatus of claim 1, wherein, upon receiving an indication of a pre-approved merchant from the second client device, the promotion engine is operable to automatically approve a request including an indication of the pre-approved merchant.

7. The apparatus of claim 1, wherein the approval of the request includes an approved reimbursement amount not equal to the reimbursement amount, and wherein the updating of the account balance and the reserve balance is based on the approved reimbursement amount.

8. A method, comprising:
providing, at a server, a promotion engine that is accessible to a plurality of users through a plurality of client systems communicatively coupled to the server via a network;
maintaining, in a data storage system, a transaction database comprising a plurality of transaction records respectively associated with a plurality of transactions, each transaction record comprising an indication of a merchant of a transaction and a transaction amount paid to the merchant in the transaction;
receiving, from a first client system of the plurality of client systems being operated by a user to access the promotion engine, promotion information comprising an indication of a selected transaction being selected from the plurality of transactions for promotion by the user, a reimbursement amount, and a target user of a second client system of the plurality of client systems;
transmitting a request to the second client system for reimbursement for the selected transaction, the request including the reimbursement amount included in the promotion information and the indication of the merchant and the transaction amount paid to the merchant included in the transaction record associated with the selected transaction; and
responsive to receiving approval of the request from the second client system: updating an account balance and a reserve balance stored within a balance database that is maintained within the data storage system by the server based on the reimbursement amount, the account balance comprising funds in an account associated with the user that are accessible to the user and the reserve balance comprising funds in the account that are inaccessible to the user; and
transmitting the updated account balance and the updated reserve balance to the first client system for rendering a current balance of the account within a user interface implemented at the first client system that specifies the updated account balance and the updated reserve balance.

9. The method of claim 8, wherein updating the account balance and the reserve balance based on the reimbursement amount comprises increasing the account balance by the reimbursement amount and decreasing the reserve balance by the reimbursement amount.

10. The method of claim 8, further comprising, upon receiving disapproval of the request from the client system, transmitting a notification of the disapproval to the first client device.

11. The method of claim 8, further comprising, after transmitting the request to the second client system and before receiving the approval, transmitting pending balance information generated based on the reimbursement amount to the first client system for rendering a pending account balance and a pending reserve balance within the user interface.

12. The method of claim 8, wherein the request further includes one or more of a message and an image input at the first client device.

13. The method of claim 8, further comprising receiving an indication of a pre-approved merchant from the second client device, and automatically approving a request including an indication of the pre-approved merchant.

14. The method of claim 8, wherein the approval of the request includes an approved reimbursement amount not equal to the reimbursement amount, and wherein the updating of the account balance and the reserve balance is based on the approved reimbursement amount.

15. A system, comprising:
a server providing a promotion engine;
a plurality of client systems configured to communicatively couple to the server via a network to access the promotion engine; and
a data storage system storing a transaction database comprising a plurality of transaction records respectively associated with a plurality of transactions, each transaction record comprising an indication of a merchant of a transaction and a transaction amount paid to the merchant in the transaction, and
wherein, upon being accessed by a user through operation of a first client system of the plurality of client systems, the promotion engine is operable to receive an indication from the first client system of a selected transaction being selected from the plurality of transactions for promotion by the user,
wherein, upon receiving promotion information specifying a target user of a second client system of the plurality of client systems from the first client system, the promotion engine is operable to transmit a request to the second client system for reimbursement for the selected transaction, the request including a reimbursement amount included in the promotion information and the indication of the merchant and the transaction amount paid to the merchant included in the transaction record associated with the selected transaction, and
wherein, upon receiving approval of the request from the second client system, the promotion engine is operable to:
update an account balance and a reserve balance stored within a balance database that is maintained within the data storage system by the server based on the reimbursement amount, the account balance comprising funds in an account associated with the user that are accessible to the user and the reserve balance comprising funds in the account that are inaccessible to the user; and
transmit the updated account balance and the updated reserve balance to the first client system for rendering a current balance of the account within a user interface implemented at the first client system that specifies the updated account balance and the updated reserve balance.

16. The system of claim 15, wherein updating the account balance and the reserve balance based on the reimbursement amount comprises increasing the account balance by the reimbursement amount and decreasing the reserve balance by the reimbursement amount.

17. The system of claim 15, wherein, upon receiving disapproval of the request from the client system, the promotion engine is operable to transmit a notification of the disapproval to the first client device.

18. The system of claim 15, wherein after transmitting the request to the second client system and before receiving the approval, the promotion engine is operable to transmit pending balance information to the first client system for rendering within the user interface that specifies a pending account balance and a pending reserve balance based on the reimbursement amount.

19. The system of claim 15, wherein the request further includes one or more of a message and an image input at the first client device.

20. The system of claim 15, wherein, upon receiving an indication of a pre-approved merchant from the second client device, the promotion engine is operable to automatically approve a request including an indication of the pre-approved merchant.
